(19) United States
(12) Patent Application Publication
(10) Pub. No.: US 2023/0186490 A1
(43) Pub. Date: Jun. 15, 2023

(54) LEARNING APPARATUS, LEARNING METHOD AND LEARNING PROGRAM

(71) Applicant: NIPPON TELEGRAPH AND TELEPHONE CORPORATION, Tokyo (JP)

(72) Inventors: Yoshiaki TAKIMOTO, Tokyo (JP); Hiroyuki TODA, Tokyo (JP); Takeshi KURASHIMA, Tokyo (JP); Shuhei YAMAMOTO, Tokyo (JP)

(73) Assignee: NIPPON TELEGRAPH AND TELEPHONE CORPORATION, Tokyo (JP)

(21) Appl. No.: 17/924,009

(22) PCT Filed: May 12, 2020
(86) PCT No.: PCT/JP2020/019009

§ 371 Date: Nov. 8, 2022

(51) Int. Cl. G06T 7/246

(52) U.S. Cl. CPC G06T 7/248; G06T 2207/20084; G06T 2207/10016; G06T 2207/20081

(57) ABSTRACT

A learning apparatus includes a memory including a first model and a second model, and a processor configured to execute causing the first model to accept a plurality of frame images included in a video as input, and output a feature vector for each frame image; causing the second model to accept the feature vector for each frame image as input, and output a temporal interval between a frame image treated as a reference and each of the frame images other than the frame image treated as the reference; and updating parameters of the first and second models such that each of the temporal intervals output from the second model approaches each temporal interval computed from time-related information pre-associated with each frame image.

### TECHNICAL FIELD

The present invention relates to a learning apparatus, a learning method, and a learning program.

### BACKGROUND ART

Generally, when classifying videos, it is important to grasp the temporal context of each frame image, and various proposals have been made in the past. For example, the non-patent literature cited below disclose technologies for estimating temporal sequence relationships among frame images in a video.

### CITATION LIST

### Non-Patent Literature

Non-Patent Literature 1: Hsin-Ying Lee, Jia-Bin Huang, Maneesh Singh, Ming-Hsuan Yang, “Unsupervised Representation Learning by Sorting Sequences”, The IEEE International Conference on Computer Vision (ICCV) 2017, pp. 667-676, 2017.

Non-Patent Literature 2: Dahun Kim, Donghyeon Cho, In So Kweon, “Self-Supervised Video Representation Learning with Space-Time Cubic Puzzles”, Vol. 33 No. 01:AAAI-19, IAAI-19, EAAI-20, pp. 8545-8552, 2019.

### SUMMARY OF THE INVENTION

### Technical Problem

Meanwhile, to grasp the temporal context of each frame image in a video, it is desirable to be capable of estimating not only the temporal sequence relationships, but also the temporal interval. This is because if the temporal interval between the frame images in a video can be estimated, it is possible to compute not only the movement direction but also properties such as the movement speed of an object included in each frame image.

In one aspect, an objective is to generate a model that estimates the temporal interval between frame images in a video.

### Means for Solving the Problem

According to an aspect of the present disclosure, a learning apparatus includes:

a first model configured to accept a plurality of frame images included in a video as input, and output a feature vector for each frame image;

a second model configured to accept the feature vector for each frame image as input, and output a temporal interval between a frame image treated as a reference and each of the frame images other than the frame image treated as the reference; and

a learning unit configured to update parameters of the first and second models such that each of the temporal intervals output from the second model approaches each temporal interval computed from time-related information pre-associated with each frame image.

### Effects of the Invention

According to the present disclosure, a model that estimates the temporal interval between frame images in a video can be generated.

### BRIEF DESCRIPTION OF DRAWINGS

FIG. 1A is a first diagram illustrating an application example of a model generated by a learning apparatus.

FIG. 1B is a second diagram illustrating an application example of a model generated by a learning apparatus.

FIG. 2 is a diagram illustrating an example of a hardware configuration of a learning apparatus.

FIG. 3 is a diagram illustrating an example of a functional configuration of a learning apparatus.

FIG. 4 is a diagram illustrating a functional configuration and a specific example of a process by a self-supervised data generation unit.

FIG. 5 is a diagram illustrating a functional configuration and a specific example of a process by a preprocessing unit.

FIG. 6 is a first diagram illustrating a functional configuration and a specific example of a process by a learning unit.

FIG. 7 is a flowchart illustrating the flow of a task implementation process.

FIG. 8 is a diagram for explaining a first Example of a pre-learning phase of the task implementation process.

FIG. 9 is a diagram for explaining a second Example of a pre-learning phase of the task implementation process.

FIG. 10 is a diagram for explaining a first Example of a fine-tuning phase of the task implementation process.

FIG. 11 is a diagram for explaining a second Example of a fine-tuning phase of the task implementation process.

FIG. 12 is a second diagram illustrating a functional configuration and a specific example of a process by a learning unit.

### DESCRIPTION OF EMBODIMENTS

Hereinafter, embodiments will be described with reference to the attached drawings. Note that, in the present specification and drawings, structural elements that have substantially the same functions and structures are denoted with the same reference signs, and duplicate description of these structural elements is omitted.

### First Embodiment

<Application Example of Model Generated by Learning Apparatus>

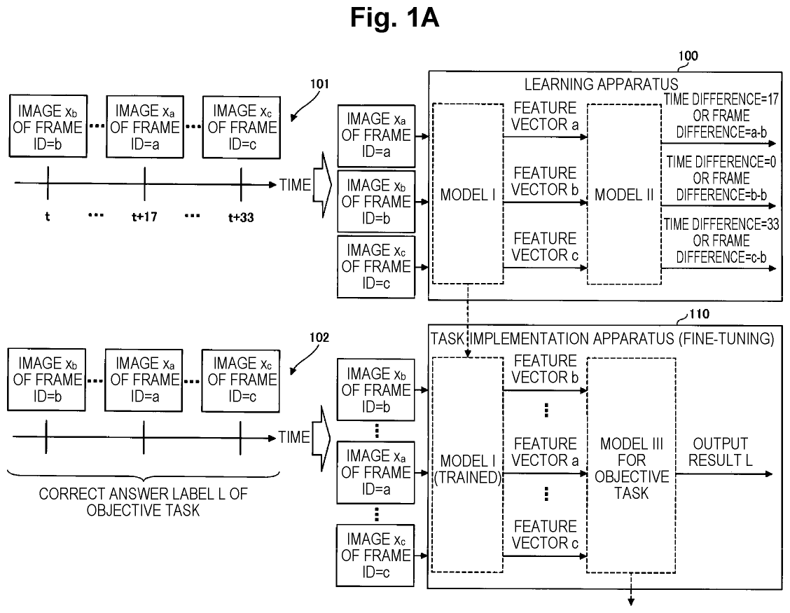

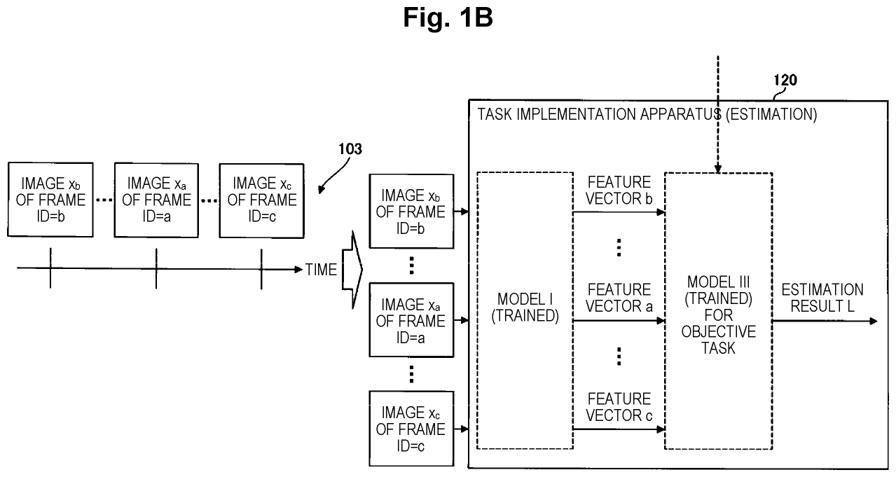

First, an application example of a model generated by a learning apparatus according to the first embodiment will be described. FIGS. 1A and 1B are first and second diagrams illustrating application examples of a model generated by a learning apparatus.

As illustrated in the upper part of FIG. 1A, a learning apparatus 100 uses a plurality of frame images in a video 101 to perform a learning process on two types of models (model I, model II). For simplicity, the example in the upper part of FIG. 1A illustrates a case where the learning process is performed using three frame images x_{b}, xₐ, x_{c} from among the plurality of frame images in the video 101.

The video 101 contains frame images captured in a temporal sequence proceeding from left to right in the upper part of FIG. 1A, and a frame ID and time information (a timestamp) are associated with each of the plurality of frame images in the video 101 as time-related information. In the example in the upper part of FIG. 1A,
frame image x_{b}: frame ID=b, time information=t,
frame image xₐ: frame ID=a, time information=t+17,
frame image x_{c}: frame ID=c, time information=t+33 are respectively associated with the three frame images x_{b}, xₐ, x_{c} used in the learning process.

Note that the two types of models (model I, model II) subjected to the learning process by the learning apparatus 100 and the model (model III) subjected to a fine-tuning process by a task implementation apparatus (fine-tuning) 110 described later are assumed to be a combination selected from among the base models
model I=2D CNN or 3D CNN,
model II=Set Transformer,
model III=Transformer, Pooling, or RNN
as options.
The base model options referred to herein indicate models that may be selected in the case of treating an image as input. Furthermore, in the case of treating sensor data or object data associated with an image as input, as in the Examples described later, other networks such as fully connected (FC) networks may also be combined. Note that CNN is an abbreviation of convolutional neural network, and RNN is an abbreviation of recurrent neural network.

As illustrated in the upper part of FIG. 1A, in the model I (=2D CNN), if the three frame images x_{b}, xₐ, x_{c} are input in a random order (in the example in the upper part of FIG. 1A, the order xₐ, x_{b}, x_{c}), a feature vector a, a feature vector b, and a feature vector c are output, respectively.

Note that although not illustrated in the upper part of FIG. 1A, in the model I (=3D CNN), respective consecutive frame image groups (x_{b}, x_{b+1}, . . . , x_{b+α}) ᵣ (xₐ, xₐ₊₁, . . . , x_{a+α}), (x_{c}, x_{c+1}, . . . , x_{c+α}) are input in a random order. Here, α denotes a number determined in advance. Also, a, b, and c are determined such that the same frame is not included in different frame image groups. Also, for convenience in the description herein, three frame image groups are assumed to be input as the consecutive frame image groups, but the number of frame image groups to be input is not limited to three (and may be increased from a, b, c to include d, e, f, and so on).

Also, if the feature vector a, the feature vector b, and the feature vector c output from the model I are input into the model II, temporal intervals between
the first frame image in the temporal sequence (the frame image treated as a reference) and
each of the second and subsequent frame images in the temporal sequence
are output.

Specifically, in the model II, the differences in the time information (respective time differences) or the differences in the frame IDs (respective frame differences) between the first frame image in the temporal sequence and each of the second and third frame images in the temporal sequence are output.

In the learning apparatus 100, the parameters of the model I and the model II are updated such that the time differences or the frame differences output from the model II approach,
time differences computed on the basis of the time information respectively associated with the frame images xₐ, x_{b}, x_{c}, or
frame differences computed on the basis of the frame IDs respectively associated with the frame images xₐ, x_{b}, x_{c}.

In the case illustrated in the upper part of FIG. 1A, the first frame image in the temporal sequence is the frame image x_{b}, and therefore the time differences computed on the basis of the time information respectively associated with the frame images xₐ, x_{b}, x_{c} are
time difference between frame image xₐ and frame image x_{b}=17,
time difference between frame image x_{b} and frame image x_{b}=0, and
time difference between frame image x_{c} and frame image x_{b}=33.

Also, in the case illustrated in the upper part of FIG. 1A, the first frame image in the temporal sequence is the frame image x_{b}, and therefore the frame differences computed on the basis of the frame IDs respectively associated with the frame images xₐ, x_{b}, x_{c} are
frame difference between frame image xₐ and frame image x_{b}=a−b,
time difference between frame image x_{b} and frame image x_{b}=b−b, and
time difference between frame image x_{c} and frame image x_{b}=c−b.

Note that the phase in which the parameters of the model I and the model II are updated through the learning process performed by the learning apparatus 100 is hereinafter referred to as the “pre-learning phase”.

When the pre-learning phase ends, the process proceeds to a “fine-tuning phase”. As illustrated in the lower part of FIG. 1A, in the fine-tuning phase, a task implementation apparatus 110 for implementing an objective task performs a fine-tuning process. To make the description easy to understand, the example in the lower part of FIG. 1A illustrates a case where the task implementation apparatus 110 performs the fine-tuning process using a plurality of frame images at least including three frame images x_{b}, xₐ, x_{c} in a video 102.

The video 102 contains frame images captured in a temporal sequence proceeding from left to right in the lower part of FIG. 1A, and a correct answer label of the objective task is associated with the video 102. The example in FIG. 1 illustrates that the correct answer label L is associated with the video 102 used in the fine-tuning process.

Note that a correct answer label of the objective task may be associated with each of the plurality of frame images including the three frame images x_{b}, xₐ, x_{c}, for example. Specifically,
frame image x_{b}: correct answer label L_{b},
frame image xₐ: correct answer label Lₐ,
frame image x_{c}: correct answer label L_{c}
may be associated.

As illustrated in the lower part of FIG. 1A, the task implementation apparatus 110 includes two types of models. Of these, the model I (trained) is a trained model I generated by having the learning apparatus 100 perform a learning process on the model I in the pre-learning phase.

On the other hand, the model III used for the objective task is a model on which a fine-tuning process is executed to implement an objective task (for example, a task of computing the movement speed of an object included in the input frame images).

As illustrated in the lower part of FIG. 1A, if a plurality of frame images including the three frame images x_{b}, xₐ, x_{c} are input into the model I (trained), a plurality of respective feature vectors including a feature vector b, a feature vector a, and a feature vector c are output. In addition, if the plurality of feature vectors including the feature vector b, the feature vector a, and the feature vector c output by the model I (trained) are input into the model III used for the objective task, an output result L corresponding to the objective task is output. Alternatively, the model III used for the objective task outputs information such as output results Lₐ, L_{b}, L_{c}.

In the task implementation apparatus 110, the parameters of the model III used for the objective task are updated (for the already-trained model I (trained), the parameters are fixed in the fine-tuning phase) such that the output result L (or the information such as output results L_{b}, Lₐ, L_{c}) output by the model III used for the objective task approach,
the correct answer label L associated with the video 102 (or information such as a correct answer label L_{b}, a correct answer label Lₐ, and a correct answer label L_{c} respectively associated with the frame images x_{b}, xₐ, x_{c}).
Note that by having the task implementation apparatus 110 perform the fine-tuning process, the parameters of the model III used for the objective task are updated, and then the fine-tuning phase ends.

When the fine-tuning phase ends, the process proceeds to an “estimation phase”. As illustrated in FIG. 1B, in the fine-tuning phase, a task implementation apparatus 120 for implementing an objective task performs an estimation process. The example in FIG. 1B illustrates a case where the task implementation apparatus 120 performs the estimation process with respect to a plurality of frame images including three frame images x_{b}, xₐ, x_{c} in a video 103.

The video 103 contains frame images captured in a temporal sequence proceeding from left to right in FIG. 1B, and the example of FIG. 1B illustrates that the plurality of frame images including the three frame images x_{b}, xₐ, x_{c} are input into the task implementation apparatus 120.

The task implementation apparatus 120 includes two types of models, of which the model I (trained) is a trained model I generated by having the learning apparatus 100 perform the learning process on the model I in the pre-learning phase.

Also, the model III (trained) used for the objective task is a trained model III generated by having the task implementation apparatus 110 perform the fine-tuning process on the model III used for the objective task.

As illustrated in FIG. 1B, if a plurality of frame images including the three frame images x_{b}, xₐ, x_{c} are input into the model I (trained), a plurality of respective feature vectors including a feature vector b, a feature vector a, and a feature vector c are output. In addition, if the plurality of feature vectors including the feature vector b, the feature vector a, and the feature vector c output by the model I (trained) are input into the model III (trained) used for the objective task, an estimation result L corresponding to the objective task is output. Alternatively, information such as an estimation result L_{b}, an estimation result Lₐ, and an estimation result L_{c} are output from the model III (trained) used for the objective task. Accordingly, when classifying the video 103 (or a plurality of frame images within the video 103), the objective task (for example, a task of computing the movement speed of an object included in the input frame images) can be implemented by the task implementation apparatus 120.

<Hardware Configuration of Learning Apparatus>

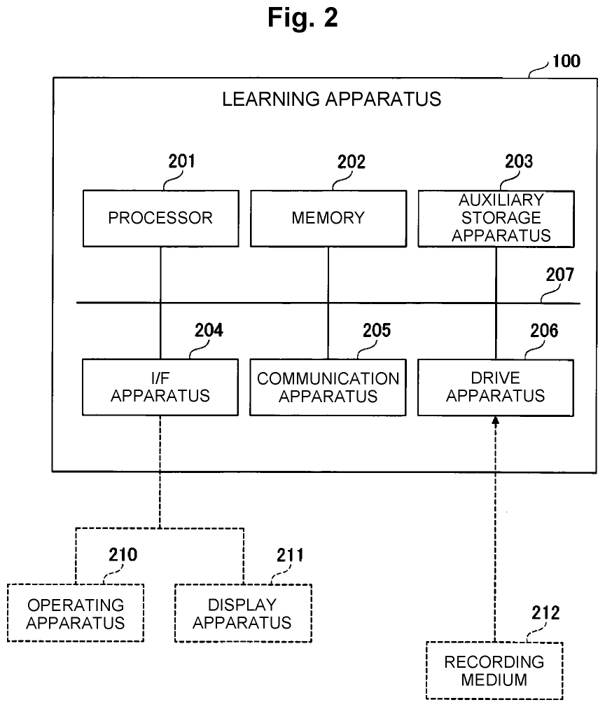

Next, a hardware configuration of the learning apparatus 100 will be described. FIG. 2 is a diagram illustrating an example of a hardware configuration of a learning apparatus. As illustrated in FIG. 2, the learning apparatus 100 includes a processor 201, a memory 202, an auxiliary storage apparatus 203, an interface (I/F) apparatus 204, a communication apparatus 205, and a drive apparatus 206. Note that the hardware components of the learning apparatus 100 are interconnected through a bus 207.

The processor 201 includes various computational apparatuses such as a central processing unit (CPU) and a graphics processing unit (GPU). The processor 201 reads and executes various programs (such as a learning program described later, for example) in the memory 202.

The memory 202 includes main memory apparatuses such as read-only memory (ROM) and random access memory (RAM). The processor 201 and the memory 202 form what is called a computer, and the computer implements various functions by causing the processor 201 to execute various read programs in the memory 202.

The auxiliary storage apparatus 203 stores various programs and various data used when the various programs are executed by the processor 201.

The I/F apparatus 204 is a connecting apparatus that connects an operating apparatus 210 and a display apparatus 211, which are examples of external apparatuses, to the learning apparatus 100. The I/F apparatus 204 receives operations with respect to the learning apparatus 100 through the operating apparatus 210. The I/F apparatus 204 also outputs results of processes performed by the learning apparatus 100 to the display apparatus 211.

The communication apparatus 205 is a communication apparatus for communicating with other apparatuses over a network.

The drive apparatus 206 is an apparatus for mounting a recording medium 212. The recording medium 212 referred to herein includes media on which information is recorded optically, electrically, or magnetically, such as a CD-ROM, a flexible disk, or a magneto-optical disc. Additionally, the recording medium 212 may also include media such as a semiconductor memory on which information is recorded electrically, such as ROM or flash memory.

Note that various programs installed in the auxiliary storage apparatus 203 may be installed by mounting a distributed recording medium 212 on the drive apparatus 206 and causing the drive apparatus 206 to read the various programs recorded on the recording medium 212, for example. Alternatively, the various programs installed in the auxiliary storage apparatus 203 may be installed by being downloaded from a network through the communication apparatus 205.

<Functional Configuration and Specific Example of Process by Learning Apparatus>

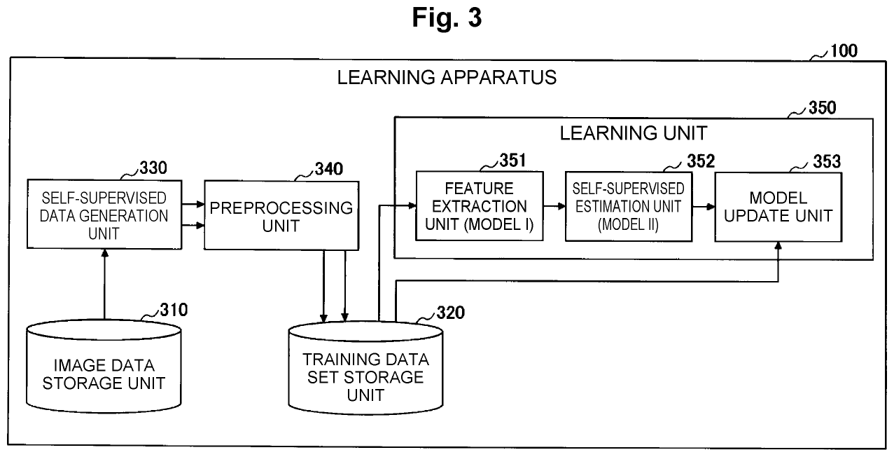

Next, a functional configuration of the learning apparatus 100 will be described. FIG. 3 is a diagram illustrating an example of a functional configuration of a learning apparatus. A learning program is installed in the learning apparatus 100, and by executing the learning program, the learning apparatus 100 functions as a self-supervised data generation unit 330, a preprocessing unit 340, and a learning unit 350 (see FIG. 3).

The self-supervised data generation unit 330 samples and reads a plurality of frame images from a video stored in an image data storage unit 310, generates and associates pseudo-labels (frame differences or time differences) with the frame images, and then randomly rearranges the frame images.

Also, the self-supervised data generation unit 330 notifies the preprocessing unit 340 of the rearranged plurality of frame images together with the associated pseudo-labels.

The preprocessing unit 340 executes various preprocesses (such as a normalization process, a cutting process, and a channel separation process, for example) on the plurality of frame images included in the notification from the self-supervised data generation unit 330. In addition, the preprocessing unit 340 stores the plurality of preprocessed frame images together with the associated pseudo-labels in a training data set storage unit 320 as a training data set.

The learning unit 350 includes a feature extraction unit 351, a self-supervised estimation unit 352, and a model update unit 353.

The feature extraction unit 351 corresponds to the model I described in FIG. 1A (one example of a first model). The learning unit 350 inputs the plurality of preprocessed frame images included in the training data set read from the training data set storage unit 320 into the feature extraction unit 351, thereby causing the feature extraction unit 351 to output feature vectors. Note that in the pre-learning phase, the parameters included in the feature extraction unit 351 are updated by the model update unit 353.

The self-supervised estimation unit 352 corresponds to the model II described in FIG. 1A (one example of a second model). The self-supervised estimation unit 352 accepts the feature vectors included in a notification from the feature extraction unit 351 as input, and outputs frame differences or time differences. Note that in the pre-learning phase, the parameters included in the self-supervised estimation unit 352 are updated by the model update unit 353.

The model update unit 353 compares the pseudo-labels (frame differences or time differences) included in the training data set read by the learning unit 350, and the training data set storage unit 320 to the frame differences or time differences output by the self-supervised estimation unit 352. Additionally, the model update unit 353 updates the parameters of the feature extraction unit 351 and the self-supervised estimation unit 352 so as to minimize the error (for example, the squared loss) between
the frame differences or time differences output by the self-supervised estimation unit 352, and
the pseudo-labels (frame differences or time differences) read by the learning unit 350.

<Details About Respective Units of Learning Apparatus>

Next, details about the respective units (the self-supervised data generation unit 330, the preprocessing unit 340, and the learning unit 350) of the learning apparatus 100 will be described.

(1) Self-Supervised Data Generation Unit

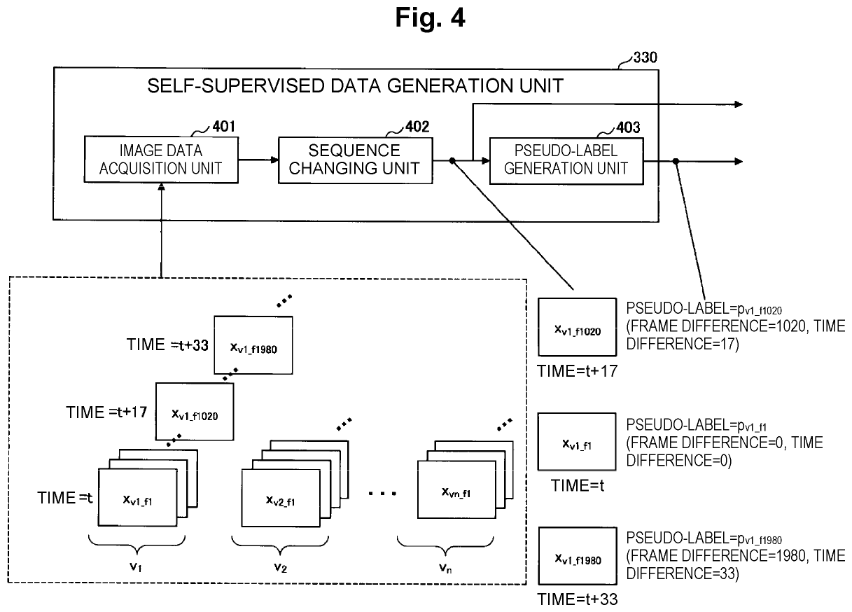

First, details about the self-supervised data generation unit 330 will be described. FIG. 4 is a diagram illustrating a functional configuration and a specific example of a process by the self-supervised data generation unit. As illustrated in FIG. 4, a plurality of videos (v₁, v₂, . . . , vₙ) are stored in the image data storage unit 310. Also, the plurality of videos (v₁, v₂, . . . , vₙ) each contain a plurality of frame images, and a frame ID and time information are associated with each of the plurality of frame images as time-related information.

Note that the following description assumes that frame IDs (for example, v1_f1, v2_f2, . . . ) including
an identifier (for example, v1, v2, . . . ) for identifying the video to which each frame image belongs, and
an identifier (for example, f1, f2, . . . ) indicating the temporal sequence of the frame images
are associated with each frame image x.

Also, the following description assumes that
time information indicating the temporal sequence in each video by treating the first frame image as t, and
time information obtained by adding the time difference from the time information t in each video (for example, . . . , t+17, . . . , t+33, . . . )
are associated with each frame image x.

As illustrated in FIG. 4, the self-supervised data generation unit 330 includes an image data acquisition unit 401, a sequence changing unit 402, and a pseudo-label generation unit 403.

The image data acquisition unit 401 samples a plurality of frame images (here, the frame images x_{v1_f1}, x_{v1_f1020}, x_{v1_f1980}) from, for example, the video v₁ from among the videos (v₁, v₂, . . . , vₙ) stored in the image data storage unit 310.

As described above, t, t+17, and t+33 are associated with the respective sampled frame images x_{v1_f1}, x_{v1_f1020}, and x_{v1_f1980} as time information. Also, v1_f1, v1_f1020, and v1_f1980 are associated with the respective sampled frame images x_{v1_f1}, x_{v1_f1020}, and x_{v1_f1980} as frame IDs.

Note that the inclusion of the first frame image of the video v₁ (the frame image with the frame ID=v1_f1) among the plurality of frame images sampled by the image data acquisition unit 401 is merely for the sake of convenience and is not a requirement. For example, the present embodiment assumes that a method of sampling on the basis of random numbers in a uniform distribution is adopted as the method of sampling the plurality of frame images read by the image data acquisition unit 401.

Also, the present embodiment assumes that a number of samples determined on the basis of a hyper parameter for example is adopted as the number of samples of the plurality of frame images read by the image data acquisition unit 401. Alternatively, it is assumed that a number of samples determined by calculation from properties such as the epoch (the number of times that all videos usable in the learning process have been used in the learning process) and the lengths of the videos is adopted.

The sequence changing unit 402 rearranges the sequence of the plurality of frame images (frame images x_{v1_f1}, x_{v1_f1020}, and x_{v1_f1980}) read by the image data acquisition unit 401. The example in FIG. 4 illustrates a rearrangement from the sequence
frame image x_{v1_f1}→frame image x_{v1_f1020}→frame image x_{v1_f1980}
to the sequence
frame image x_{v1_f1020}→frame image x_{v1_f1}→frame image x_{v1_f1980}.

The pseudo-label generation unit 403 generates pseudo-labels (p_{v1_f1020}, p_{v1_f1}, and p_{v1_f1980}) for the rearranged plurality of frame images (frame images x_{v1_f1020}, x_{v1_f1}, and x_{v1_f1980}). As described above, frame differences or time differences are included in the pseudo-labels, and the frame differences in the read plurality of frame images (frame images x_{v1_f1}, x_{v1_f1020}, and x_{v1_f1980}) are calculated according to the differences in the frame IDs between
the frame ID (v1_f1) associated with the first frame image (frame image x_{v1_f1}) in the temporal sequence, and
the frame IDs (v1_f1020 and v1_f1980) associated with the other frame images (x_{v1_f1020} and x_{v1_f1980}).

Also, the time differences in the read plurality of frame images (frame images x_{v1_f1}, x_{v1_f1020}, and x_{v1_f1980}) are calculated according to the differences in the time information between
the time information (t) associated with the first frame image (frame image x_{v1_f1}) in the temporal sequence, and
the time information (t+17 and t+33) associated with the other frame images (x_{v1_f1020} and x_{v1_f1980}).

Consequently, as illustrated in FIG. 4,
frame difference=1020 or time difference=17,
frame difference=0 or time difference=0, and
frame difference=1980 or time difference=33
are respectively included in the generated pseudo labels (p_{v1_f1020}, p_{v1_f1}, and p_{v1_f1980}0.

(2) Preprocessing

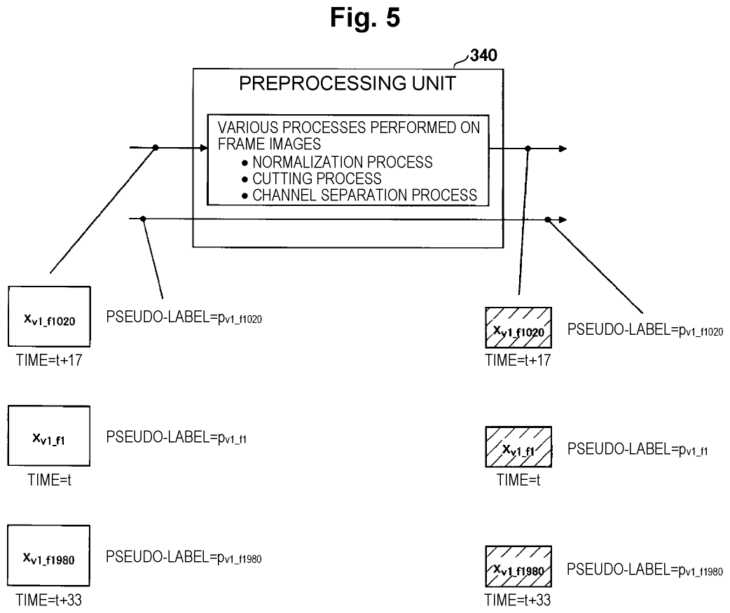

Next, details about the preprocessing unit 340 will be described. FIG. 5 is a diagram illustrating a functional configuration and a specific example of a process by a preprocessing unit. As illustrated in FIG. 5, the preprocessing unit 340 executes various processes (such as a normalization process, a cutting process, and a channel separation process) on the rearranged plurality of frame images (frame images x_{v1_f1020}, x_{v1_f1}, and x_{v1_f1980}).

Specifically, in the case where sensor data is associated with each of the plurality of frame images, the preprocessing unit 340 performs a normalization process on each of the plurality of frame images on the basis of the sensor data. Note that sensor data refers to data indicating an image capture status when the plurality of frame images were captured (for example, in the case where the image capture apparatus is mounted on a moving object, data such as movement speed data and position data of the moving object).

Additionally, the preprocessing unit 340 performs a cutting process of cutting out an image of a predetermined size from each of the plurality of frame images to. For example, the preprocessing unit 340 may be configured to cut out a plurality of images at different cutting positions from a single frame image.

In addition, the preprocessing unit 340 performs a channel separation process of selecting an image of a specific color component from among the images of each color component (R image, G image, B image) included in each of the plurality frame images, and replacing the value of each pixel with the selected color component. For example, the preprocessing unit 340 may be configured to perform the channel separation process such that an (R, G, B) frame image is converted to (R, R, R), (G, G, G), or (B, B, B).

Note that the above preprocesses are examples, and the preprocessing unit 340 may also executed a preprocess other than the above on each of the plurality of frame images. Moreover, the preprocessing unit 340 may execute all of the above preprocesses or only a portion of the above preprocesses.

The example in FIG. 5 illustrates a situation in which the preprocessing unit 340 has executed a cutting process on the rearranged plurality of frame images (frame images x_{v1_f1020}, x_{v1_f1}, and x_{v1_f1980}).

(3) Learning Unit

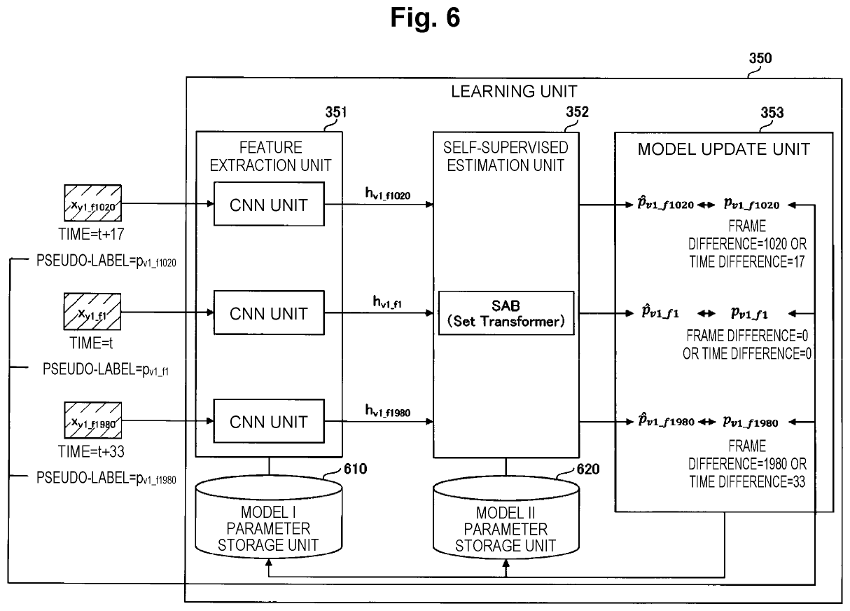

Next, details about the learning unit 350 will be described. FIG. 6 is a first diagram illustrating a functional configuration and a specific example of a process by the learning unit. As illustrated in FIG. 6, the feature extraction unit 351 includes CNN units, and repeatedly performs a nonlinear transform on the preprocessed plurality of frame images (frame images x_{v1_f1020}, x_{v1_f1}, and x_{v1_f1980}), and outputs feature vectors. The example in FIG. 6 illustrates a situation in which feature vectors h_{v1_f1020}, h_{v1_f1}, and h_{v1_f1980} are output.

Also, as illustrated in FIG. 6, the self-supervised estimation unit 352 corresponds to an SAB layer (or ISAB layer) of the Set Transformer. Note that the self-supervised estimation unit 352 may contain one or multiple layers. The self-supervised estimation unit 352 repeatedly executes a nonlinear transform on the feature vectors (h_{v1_f1020}, h_{v1_f1}, and h_{v1_f1980}) output by the feature extraction unit 351 in layers having group equivariance. Note that a layer having group equivariance refers to a layer having the following attributes:
the inputs and the outputs correspond to each other, and
if the input sequence is rearranged, the output sequence is also rearranged in correspondence with the input.

Also, in the final layer, the self-supervised estimation unit 352 converts each feature vector (h_{v1_f1020}, h_{v1_f1}, and h_{v1_f1980}) to a one-dimensional scalar value. Accordingly, the self-supervised estimation unit 352 outputs

\hat{p}_{v1_f1020},

\hat{p}_{v1_f1},

\hat{p}_{v1_f1980}, [Math. 1]

as the frame differences or the time differences.

The model update unit 353 acquires

p_{v1_f1020},

p_{v1_f1},

p_{v1_f1980}, [Math. 2]

as the pseudo-labels (frame differences or time differences) included in the training data set read by the learning unit 350 from the training data set storage unit 320.

The model update unit 353 also compares the frame differences or time differences output by the self-supervised estimation unit 352, and the pseudo-labels (frame differences or time differences) included in the training data set. Furthermore, the model update unit 353 updates the parameters of the feature extraction unit 351 and the parameters of the self-supervised estimation unit 352 so as to minimize the error in the comparison result.

In the case of the example in FIG. 6, the model update unit 353 updates the parameters of the feature extraction unit 351 and the parameters of the self-supervised estimation unit 352 such that
for the preprocessed frame image x_{v1_f1020}, the frame difference becomes 1020 (or the time difference becomes 17),
for the preprocessed frame image x_{v1_f1}, the frame difference becomes 0 (or the time difference becomes 0), and
for the preprocessed frame image x_{v1_f1980}, the frame difference becomes 1980 (or the time difference becomes 33).

Note that the model update unit 353 stores the updated parameters of the feature extraction unit 351 in a model I parameter storage unit 610 (although the feature extraction unit 351 includes a plurality of CNN units, the parameters are assumed to be shared). The model update unit 353 also stores the updated parameters of the self-supervised estimation unit 352 in a model II parameter storage unit 620.

<Flow of Task Implementation Process>

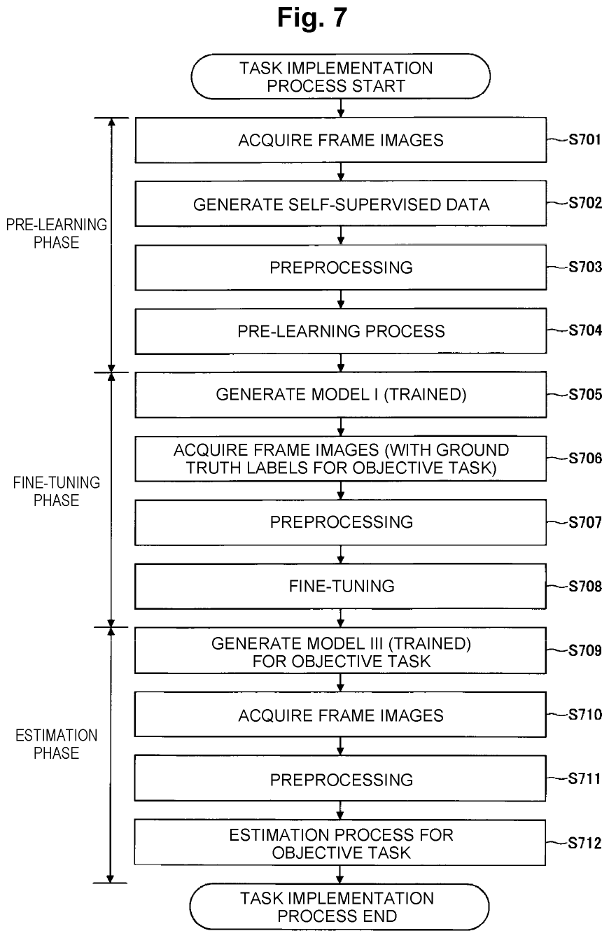

Next, the overall flow of the task implementation process will be described. FIG. 7 is a flowchart illustrating the flow of the task implementation process.

In step S701 of the pre-learning phase, the self-supervised data generation unit 330 of the learning apparatus 100 acquires a plurality of frame images.

In step S702 of the pre-learning phase, the self-supervised data generation unit 330 of the learning apparatus 100 generates pseudo-labels and then randomly rearranges the plurality of frame images.

In step S703 of the pre-learning phase, the preprocessing unit 340 of the learning apparatus 100 executes preprocessing on the randomly rearranged plurality of frame images.

In step S704 of the pre-learning phase, the learning unit 350 of the learning apparatus 100 executes learning using the preprocessed plurality of frame images and the corresponding pseudo-labels, and updates the parameters of the feature extraction unit 351 and the parameters of the self-supervised estimation unit 352.

Next, the flow proceeds to the fine-tuning phase. In step S705 of the fine-tuning phase, the task implementation apparatus 110 applies the parameters of the feature extraction unit 351 and generates the model I (trained).

In step S706 of the fine-tuning phase, the task implementation apparatus 110 acquires a plurality of frame images with associated correct answer labels for the objective task.

In step S707 of the fine-tuning phase, the task implementation apparatus 110 executes preprocessing as in step S703.

In step S708 of the fine-tuning phase, the task implementation apparatus 110 executes the fine-tuning process using the preprocessed plurality of frame images and the correct answer labels, and updates the parameters of the model III used for the objective task.

Next, the flow proceeds to the estimation phase. In step S709 of the estimation phase, the task implementation apparatus 110 applies the parameters of the model III used for the objective task to generate the model III (trained) used for the objective task.

In step S710 of the estimation phase, the task implementation apparatus 110 acquires a plurality of frame images.

In step S711 of the estimation phase, the task implementation apparatus 110 executes preprocessing similarly to step S703.

In step S712 of the estimation phase, the task implementation apparatus 110 executes the estimation process for the objective task by treating the preprocessed plurality of frame images as input.

### EXAMPLES

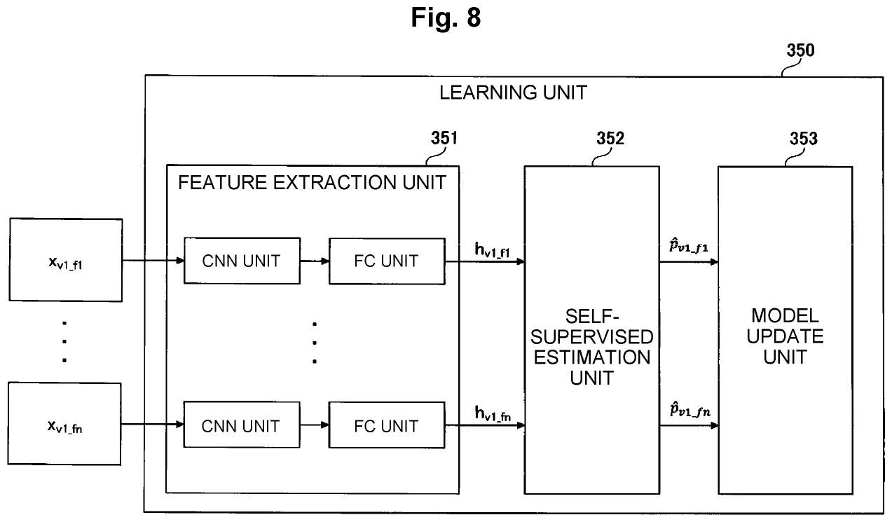

Next, specific Examples (Example 1 and Example 2) of the task implementation process will be described using FIGS. 8 to 11.

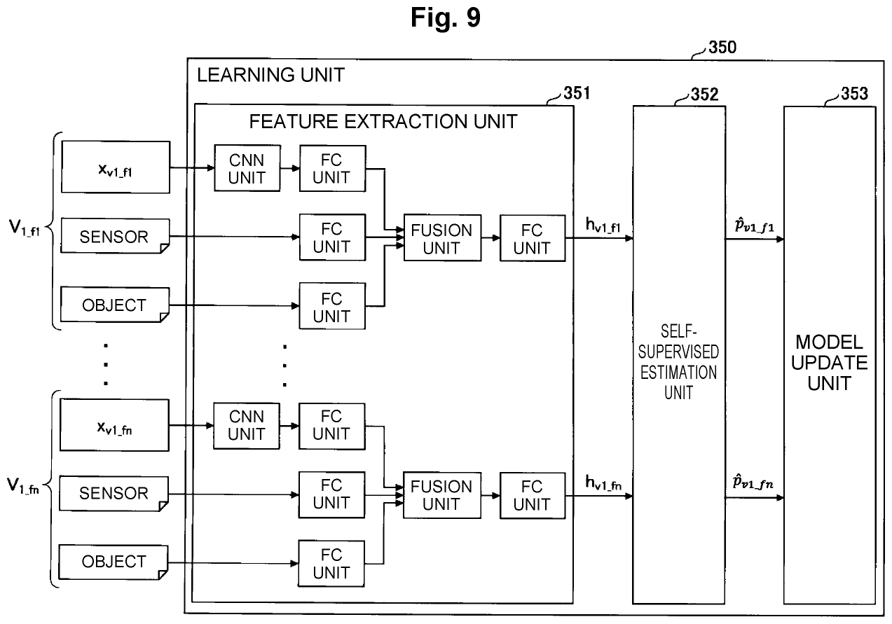

FIGS. 8 and 9 are diagrams for explaining first and second Examples of the pre-learning phase of the task implementation process. As illustrated in FIG. 8, the first Example illustrates a case where the learning unit 350 inputs n frame images x_{v1_f1} to x_{v1_fn} included in a video v1 into the feature extraction unit 351 and executes the learning process. The video v1 is a video recorded by a dashboard camera, for example. Also, the n frame images x_{v1_f1} to x_{v1_fn} are frame images obtained after performing a normalization process using sensor data and furthermore performing a cutting process and a channel separation process, for example. Also, as illustrated in FIG. 8, in the case of the first Example, the feature extraction unit 351 includes CNN units that perform convolutional processing and the like, and FC units that perform a nonlinear transform using a function such as a sigmoid function or a ReLu function.

In the first Example, under the above preconditions, feature vectors h_{v1_f1}, . . . , h_{v1_fn} are output by the feature extraction unit 351, and the pseudo-labels

\hat{p}_{v1_f1}, . . . \hat{p}_{v1_fn1} [Math. 3]

are output by the self-supervised estimation unit 352. Furthermore, the parameters of the feature extraction unit 351 and the parameters of the self-supervised estimation unit 352 are updated by the model update unit 353.

On the other hand, as illustrated in FIG. 9, the second Example illustrates a case where the learning unit 350 inputs n sets (sets of a frame image, sensor data, and object data) v_{1_f1} to v_{1_fn} included in a video v1 into the feature extraction unit 351 and executes the learning process. Note that object data refers to data indicating an attribute (such as vehicle or person, for example) of an object included in a frame image. In this way, by inputting sensor data and object data, a more accurate learning process can be implemented. This is because when outputting the temporal interval, information indicating from where to where the same object is moving in the frame images is important information.

As in the first Example, the video v1 is a video recorded by a dashboard camera, for example. Also, the n frame images x_{v1_f1} to x_{v1_fn} are frame images obtained after performing a normalization process using sensor data and furthermore performing a cutting process and a channel separation process, for example.

However, in the second Example, the feature extraction unit 351 includes CNN units and FC units that process the frame images, FC units that process the sensor data, and FC units that process the object data. Additionally, in the second Example, the feature extraction unit 351 includes a fusion unit and an FC unit that process the frame images, sensor data, and object data processed by the above units.

In the second Example, under the above preconditions, feature vectors h_{v1_f1}, . . . , h_{v1_fm} are output by the feature extraction unit 351, and the pseudo-labels

\hat{p}_{v1_f1}, . . . \hat{p}_{v1_fn1} [Math. 4]

are output by the self-supervised estimation unit 352. Furthermore, the parameters of the feature extraction unit 351 and the parameters of the self-supervised estimation unit 352 are updated by the model update unit 353.

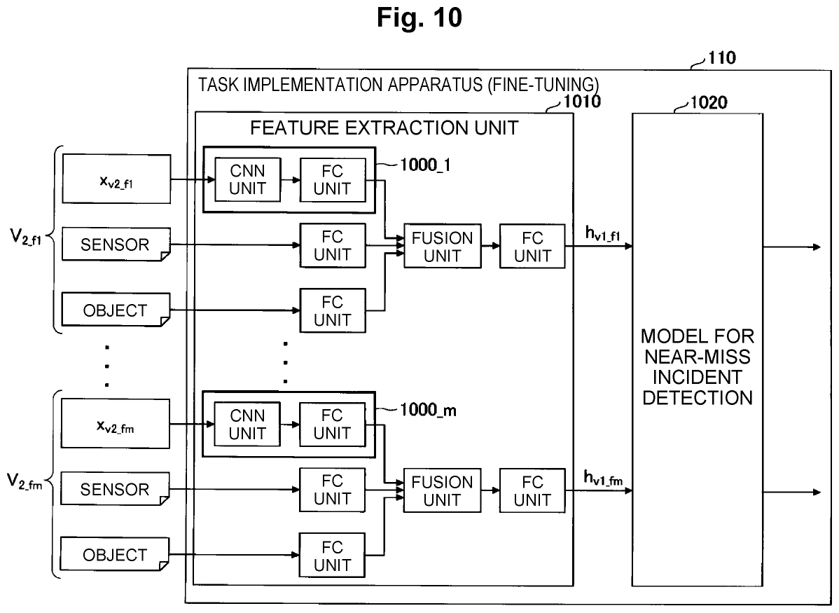

FIG. 10 is a diagram for explaining a first Example of the fine-tuning phase of the task implementation process. The task implementation apparatus 110 illustrated in FIG. 10 illustrates a case where m sets (sets of a frame image, sensor data, and object data) v_{2_f1} to v_{2_fm} included in a video v2 are input into a feature extraction unit 1010, and the fine-tuning process is executed. As in the pre-learning phase described with reference to FIG. 8, the video v2 is a video recorded by a dashboard camera, for example, and correct answer labels (annotation data) are associated with each frame image. Also, the m frame images x_{v2_f1} to x_{v2_fm} are frame images obtained after performing a normalization process using sensor data and furthermore performing a cutting process and a channel separation process, for example.

Additionally, the parameters of the feature extraction unit 351 updated by executing the learning process in the pre-learning phase described using FIG. 8 are applied to the feature extraction unit 1010 of the task implementation apparatus 110 illustrated in FIG. 10 (see signs 1000_1 to 1000_m). Note that although the network structure inside the feature extraction unit 1010 also includes processing units other than the processing units explicitly illustrated in FIG. 10, for simplicity, only part of the network structure is explicitly illustrated in FIG. 10.

Furthermore, in the task implementation apparatus 110 illustrated in FIG. 10, a model 1020 for near-miss incident detection is applied as the model III used for the objective task, and the parameters of the model 1020 for near-miss incident detection are updated by executing the fine-tuning process.

By having the task implementation apparatus 110 illustrated in FIG. 10 complete the fine-tuning process, it is possible to detect near-miss incidents, classify near-miss incidents (such as an incident involving another vehicle or an incident involving a bicycle), and the like from the frame images included in a video recorded by a dashboard camera, for example.

This is because the feature vectors output from the feature extraction unit 1010 include information indicating the temporal interval between the frame images within the same video, thereby making it easy to grasp
the movement direction and speed with respect to a nearby object (such as a vehicle, a bicycle, or a pedestrian),
changes in the surrounding environment (such as walls and roads), and
changes in the state (speed, acceleration) of one's own vehicle
   (what is called the temporal context), which is important when detecting near-miss incidents in the model 1020 for near-miss incident detection.

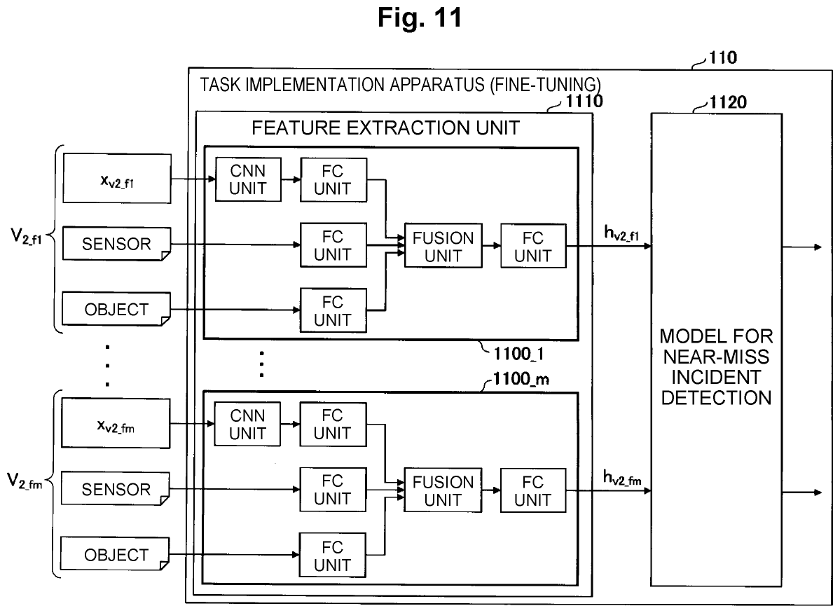

FIG. 11 is a diagram for explaining a second Example of the fine-tuning phase of the task implementation process. The task implementation apparatus 110 illustrated in FIG. 11 illustrates a case where m sets (sets of a frame image, sensor data, and object data) v_{2_f1} to v_{2_fm} included in a video v2 are input into the feature extraction unit 351, and the fine-tuning process is executed. As in the pre-learning phase described with reference to FIG. 9, the video v2 is a video recorded by a dashboard camera, for example, and correct answer labels (annotation data) are associated with each frame image. Also, the m frame images x_{v2_f1} to x_{v2_fm} are frame images obtained after performing a normalization process using sensor data and furthermore performing a cutting process and a channel separation process, for example.

Additionally, the parameters of the feature extraction unit 351 updated by executing the learning process in the pre-learning phase described using FIG. 9 are applied to the feature extraction unit 1110 of the task implementation apparatus 110 illustrated in FIG. 11 (see signs 1100_1 to 1100_m). Note that although the network structure inside the feature extraction unit 1110 also includes processing units other than the processing units explicitly illustrated in FIG. 11, for simplicity, only part of the network structure is explicitly illustrated in FIG. 11.

Furthermore, in the task implementation apparatus 110 illustrated in FIG. 11, a model 1120 for near-miss incident detection is applied as the model III used for the objective task, and the parameters of the model 1120 for near-miss incident detection are updated by executing the fine-tuning process.

By having the task implementation apparatus 110 illustrated in FIG. 11 complete the fine-tuning process, it is possible to detect near-miss incidents, classify near-miss incidents (such as an incident involving another vehicle or an incident involving a bicycle), and the like from the frame images included in a video recorded by a dashboard camera, for example.

### OTHER EXAMPLES

Although Examples 1 and 2 above describe a case of detecting or classifying near-miss incidents by using a video recorded by a dashboard camera, a specific examples of the task implementation apparatus are not limited thereto. For example, a task implementation apparatus that recognizes human behavior may also be constructed by using frame images in a video in which people are moving.

In such a case, a configuration similar to Examples 1 and 2 above may also be used to execute a learning process and a fine-tuning process in the pre-learning phase and the fine-tuning phase, and thereby construct a task implementation apparatus that recognizes human behavior from frame images.

This is because it is easy to grasp
the movement and speed of people
(what is called the temporal context), which is important when recognizing human behavior in the model for human behavior recognition, as the feature vectors output from the feature extraction unit include information indicating the temporal interval between the frame images within the same video, and further, by using the feature vectors, it is easy to separate people from an unchanging background.

<Conclusion>

As is clear from the above description, the learning apparatus 100 according to the first embodiment
includes a feature extraction unit that accepts a plurality of frame images as input, and outputs a feature vector for each frame image,
includes a self-supervised estimation unit that accepts the feature vectors output by the feature extraction unit as input, and outputs the temporal interval between a frame image treated as a reference (the first frame image in the temporal sequence) and each of the frame images other than the frame image treated as the reference, and
updates the parameters of the feature extraction unit and the self-supervised estimation unit such that each of the temporal intervals output from the self-supervised estimation unit approaches each of the temporal intervals (pseudo-labels) computed from the time-related information pre-associated with each frame image.

With this configuration, according to the learning apparatus 100 according to the first embodiment, a model that estimates the temporal interval between frame images in a video can be generated.

### Second Embodiment

The first embodiment above describes a case of computing pseudo-labels (frame differences or time differences) as the temporal interval on the basis of time-related information pre-associated with each frame image. However, the temporal interval computed on the basis of the time-related information is not limited to frame differences or time differences, and temporal intervals corresponding to the objective task may also be computed as the pseudo-labels.

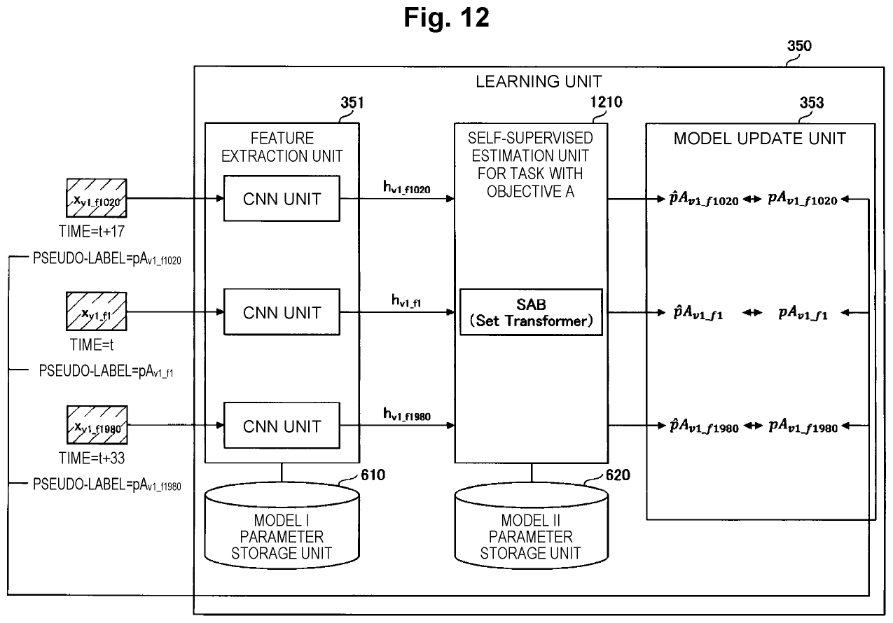

FIG. 12 is a second diagram illustrating a functional configuration and a specific example of a process by a learning unit. The case of FIG. 12 differs from FIG. 6 in that pseudo-labels corresponding to a task with an objective A

pA_{v1_f1020},

pA_{v1_f1},

pA_{v1_f1980}, [Math. 5]

are input into the model update unit 353 as the pseudo-labels.

Also, in the case of FIG. 12, the learning unit 350 includes a self-supervised estimation unit 1210 for the task with the objective A instead of the self-supervised estimation unit 352, and outputs

\hat{p}A_{v1_f1020},

\hat{p}A_{v1_f1},

\hat{p}A_{v1_f1980}, [Math. 6]

as the temporal intervals corresponding to the task with the objective A.

In this way, in the pre-learning phase, the learning unit 350 may perform the learning process using temporal intervals corresponding to the objective task.

### Other Embodiments

In the first embodiment above, the image data acquisition unit 401 is described as sampling a plurality of frame images on the basis of random numbers in a uniform distribution. However, the sampling method used by the image data acquisition unit 401 when sampling a plurality of frame images is not limited to the above.

For example, the image data acquisition unit 401 may also prioritize reading out frame images with a large amount of movement according to optical flow, or reference sensor data associated with the frame images (details to be described later) and prioritize reading out frame images that satisfy a predetermined condition.

Also, in the second Example of the first embodiment above, the task implementation apparatus 110 is described as inputting sets of a frame image, sensor data, and object data included in the video image v2 into the feature extraction unit. However, it is not necessary to input both the sensor data and the object data, and it is also possible to input only one of the sensor data or the object data.

Note that the present invention is not limited to the configurations indicated here, such as combinations with other elements in the configurations and the like cited in the above embodiments. These points can be changed without departing from the gist of the present invention, and can be defined appropriately according to the form of application.

### REFERENCE SIGNS LIST

100 learning apparatus

110 task implementation apparatus (fine-tuning)

120 task implementation apparatus (estimation)

330 self-supervised data generation unit

340 preprocessing unit

350 learning unit

351 feature extraction unit

352 self-supervised estimation unit

353 model update unit

303 frequency analysis unit

304 data generation unit

320 training data set storage unit

1010 feature extraction unit

1020 model for near-miss incident detection

1110 feature extraction unit

1120 model for near-miss incident

1210 self-supervised estimation unit for task with objective A

1. A learning apparatus comprising:
a memory including a first model and a second model; and
a processor configured to execute:
causing the first model to accept a plurality of frame images included in a video as input, and output a feature vector for each frame image;
causing the second model to accept the feature vector for each frame image as input, and output a temporal interval between a frame image treated as a reference and each of the frame images other than the frame image treated as the reference; and
updating parameters of the first and second models such that each of the temporal intervals output from the second model approaches each temporal interval computed from time-related information pre-associated with each frame image.

2. The learning apparatus according to claim 1, wherein the processor is further configured to execute:
changing a temporal sequence of the frame images,
generating information indicating a time difference or a difference in a frame ID between the frame image treated as the reference being a first frame image in the temporal sequence, and each of a second frame image and subsequent frame images among the frame images, and
storing in the memory information indicating each time difference or difference in the frame ID in association with the frame images for which the temporal sequence has been changed,
causing the first model to accept each frame image stored in the memory as input, and output a feature vector of each frame image, and
updating the parameters of the first and second models such that the information indicating each time difference or difference in the frame ID output from the second model approaches the information indicating each time difference or difference in the frame ID stored in association with each frame image in the memory.

3. The learning apparatus according to claim 2, wherein the processor is further configured to execute causing the first model to accept a plurality of frame images included in the video and either or both of sensor data associated with each frame image or information related to an object included in each frame image as input, and output the feature vector for each frame image.

4. A learning method executed by a computer including a memory including a first model and a second model, and a processor, the learning method comprising:
causing the first model to accept a plurality of frame images included in a video as input, and output a feature vector for each frame image;
causing the second model to accept the feature vector for each frame image as input, and output a temporal interval between a frame image treated as a reference and each of the frame images other than the frame image treated as the reference; and
updating parameters of the first and second models such that each of the temporal intervals output from the second model approaches each temporal interval computed from time-related information pre-associated with each frame image.

5. A non-transitory computer-readable recording medium having computer-readable instructions stored thereon, which when executed, cause a computer including a memory including a first model and a second model, and a processor to execute a learning process comprising:
causing the first model to accept a plurality of frame images included in a video as input, and output a feature vector for each frame image;
causing the second model to accept the feature vector for each frame image as input, and output a temporal interval between a frame image treated as a reference and each of the frame images other than the frame image treated as the reference; and
updating parameters of the first and second models such that each of the temporal intervals output from the second model approaches each temporal interval computed from time-related information pre-associated with each frame image.
